(19) United States
(12) Patent Application Publication
(10) Pub. No.: US 2003/0131694 A1
(43) Pub. Date: Jul. 17, 2003

(54) Bit receiving device having a movable magnetic rod

(76) Inventor: Ing-Mo Lin, Chang Hua City (TW)

Correspondence Address: Charles E. Baxley, Hart, Baxley, Daniels & Holton, 59 John Street, Fifth Floor, New York, NY, 10038, US

(21) Appl. No.: 10/043,819

(22) Filed: Jan. 14, 2002

(51) Int. Cl. B25B 23/00

(52) U.S. Cl. 81/438

(57) ABSTRACT

A bit receiving device includes a shank having a first polygonal recess in for receiving a bit therein. A second polygonal recess is defined in a second end of the shank for receiving an extension rod therein. A chamber is longitudinally defined in the shank and a flange extends inward from an inner periphery of the chamber. The chamber has an inner diameter which is larger than an inner diameter defined by the flange. A rod is movably received in the first chamber and a magnetic member is connected to a first end of the rod. A second end of the rod is an enlarged end which is stopped by the flange when the rod is extended from the first polygonal recess.

### FIELD OF THE INVENTION

The present invention relates to a bit receiving device that has a magnetic rod movably received in the device and the magnetic rod can be extended from an end of the device when removing a bit from the device.

### BACKGROUND OF THE INVENTION

A conventional bit receiving device is shown in FIG. 5 and generally includes a shank 30 with two open ends 34, 340 and each of the two open ends 34, 340 has a hexagonal inside so that an extension rod 31 is engaged with one of the open ends, and the other open end 34 is to receive a bit 310 therein. The extension rod 31 is used to cooperate with other tool so as to let the bit 310 reach a deep inside of objects. In order to make the open ends 34, 340, two circular chambers 330, 320 are defined in the shank 30 as shown. The inner diameter of the chamber 330 is smaller than that of the other chamber 320 so that the rear end of the bit 310 is stopped by the periphery of the chamber 330. The length or depth of the open end 34 is limited within a range so that there cannot be other function by cooperating with the chamber 330 and the open end 34.

The present invention intends to provide a bit receiving device having a magnetic rod movably received therein which can extend out from the device when removing the bit, and the magnetic rod extending from the device is used to pick small items.

### SUMMARY OF THE INVENTION

In accordance with one aspect of the present invention, there is provided a bit receiving device which comprises a shank having a recess defined in a first end of the shank so as to receive a bit therein. A chamber is longitudinally defined in the shank and shares a common axis with the first polygonal recess. A flange extends inward from an inner periphery of the chamber and an inner diameter defined by the first chamber is larger than that defined by the flange. A rod is movably received in the chamber and a magnetic member is connected to a first end of the rod. A second end of the rod is an enlarged end which has an outer diameter larger than the inner diameter defined by the flange.

The primary object of the present invention is to provide a bit receiving device that has a movable rod received therein and a magnetic member is connected to a distal end of the rod. The rod is extended from the shank of the device when removing a bit from the shank.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the bit receiving device of the present invention;

FIG. 2 is an exploded view to show a rod received in the device, a magnetic member and a seal to be mounted to the rod;

FIG. 3 is a cross sectional view to show the assembly of the rod, the magnetic member and the seal;

FIG. 4 shows that the magnetic member on the rod is extended from the shank when removing the bit from the shank, and

FIG. 5 shows a conventional bit receiving device.

### DETAILED DESCRIPTION OF THE PREFERRED EMBODIMENT

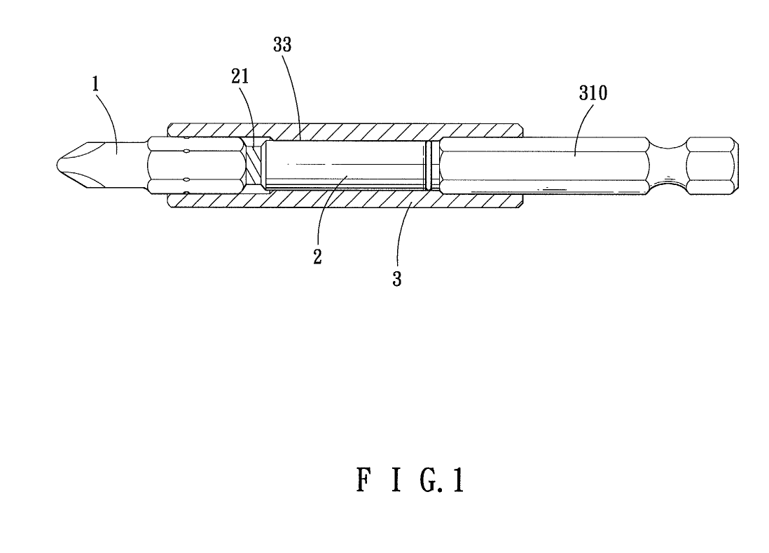

Referring to FIGS. 1 to 3, the bit receiving device of the present invention comprises a shank 3 having a first polygonal recess 30 defined in a first end of the shank 3 and a second polygonal recess 300 defined in a second end of the shank 3. A bit 1 can be engaged with the first polygonal recess 30 and an extension rod 310 can be engaged with the second polygonal recess 300. A chamber 32 is longitudinally defined in the shank 3 and shares a common axis 35 with the first polygonal recess 30 and the second polygonal recess 300.

A flange 33 extends inward from an inner periphery of the chamber 32. The flange 33 can be an annular flange or several protrusions. The chamber 32 has an inner diameter which is larger than an inner diameter defined by the flange 33.

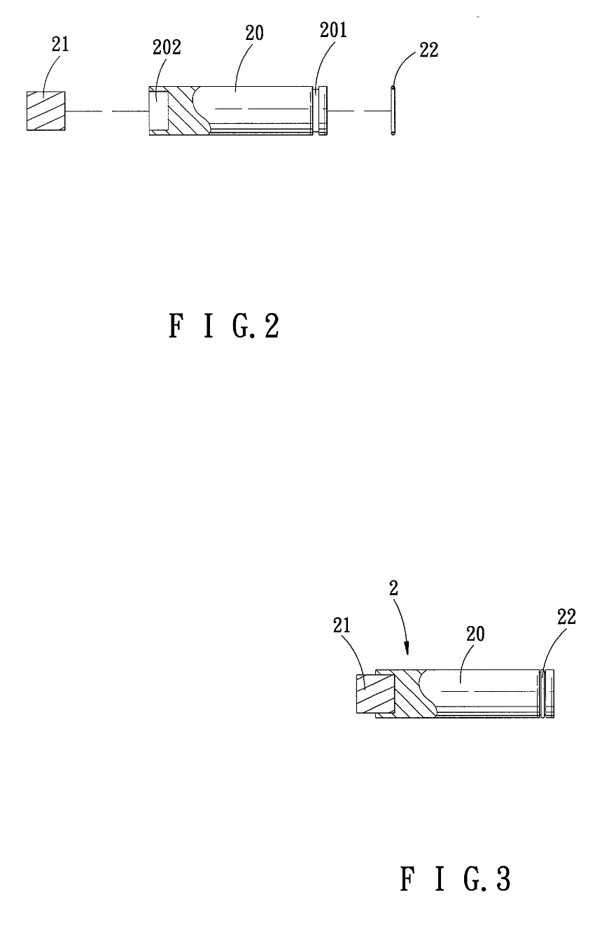

As shown in FIG. 2 and 3, a rod 2 is movably received in the chamber 32 and a magnetic member 21 connected to a recess 202 defined in a first end of the rod 2. An annular groove 201 is defined in the second end of the rod 2 and a seal 22 is engaged with the annular groove 201. The seal 22 forms an enlarged end on the second end of the rod 2 which has an outer diameter larger than the inner diameter defined by the flange 33.

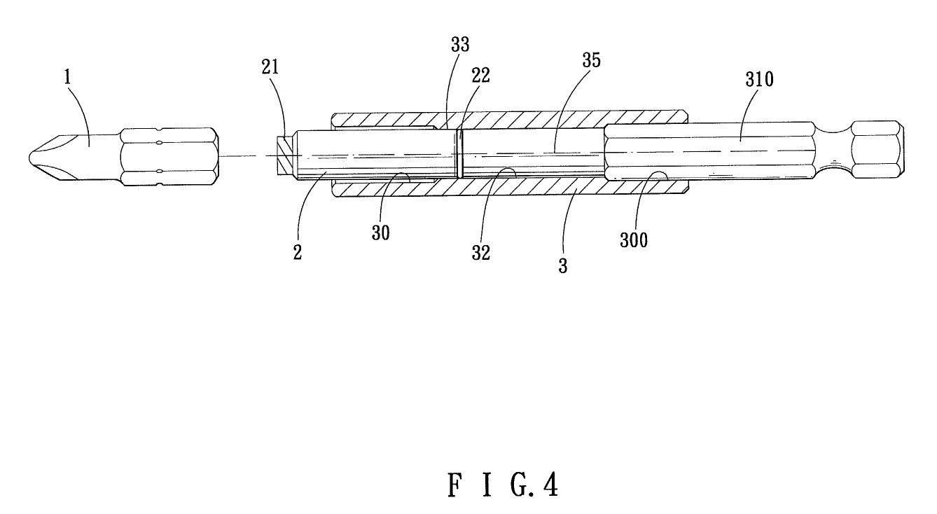

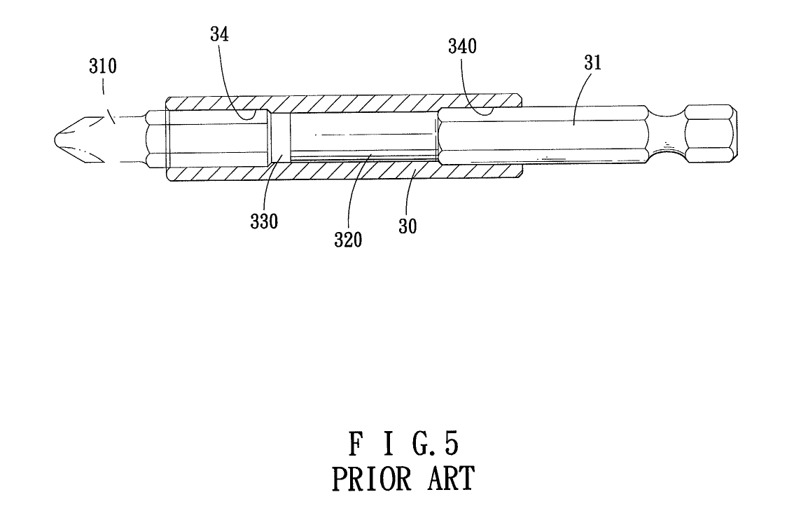

As shown in FIG. 4, when removing the bit 1 from the first polygonal recess 30, the magnetic member 21 is attracted together with the bit 1 and is moved to be extended from the first polygonal recess 30 till the seal 22 is stopped by the flange 33. The magnetic member 21 can be used to pick small metal items.

While we have shown and described the embodiment in accordance with the present invention, it should be clear to those skilled in the art that further embodiments may be made without departing from the scope of the present invention.

What is claimed is:

1. A bit receiving device comprising:
a shank having a first polygonal recess defined in a first end of said shank, a chamber longitudinally defined in said shank and sharing a common axis with said first polygonal recess, a flange extending inward from an inner periphery of said chamber, said chamber having an inner diameter which is larger than an inner diameter defined by said flange, and
a rod movably received in said chamber and a magnetic member connected to a first end of said rod, a second end of said rod being an enlarged end which has an outer diameter larger than said inner diameter defined by said flange.

2. The device as claimed in claim 1, wherein a second polygonal recess is defined in a second end of said shank and an extension rod is engaged with said second polygonal recess.

3. The device as claimed in claim 1 further comprising an annular groove defined in said second end of said rod and a seal is engaged with said annular groove.
